(19) United States
(12) Patent Application Publication
(10) Pub. No.: US 2015/0087412 A1
(43) Pub. Date: Mar. 26, 2015

(54) GAMING SYSTEM HAVING ELIGIBILITY ROUTINE FOR GROUP PLAY

(71) Applicant: King Show Games, Inc., Minnetonka, MN (US)

(72) Inventors: Bradley BERMAN, Minnetonka, MN (US); Peter BERMAN, Minneapolis, MN (US); Jacob LAMB, Maple Grove, MN (US)

(73) Assignee: King Show Games, Inc., Minnetonka, MN (US)

(21) Appl. No.: 14/033,123

(22) Filed: Sep. 20, 2013

(51) Int. Cl. G07F 17/32

(52) U.S. Cl. CPC G07F 17/3272
USPC 463/29

(57) ABSTRACT

Embodiments of the present invention set forth systems, apparatuses and methods for implementing an eligibility routine for group play involving one or more gaming devices. This routine includes making at least two distinct determinations regarding trigger conditions that need to be met before proceeding to a group play game event, such as a community bonus. A first determination is made to eliminate a number of triggering opportunities without interrupting game play of one or more primary base games being played on the gaming devices. A second determination is made when conditions relating to the first determination are satisfied. The second determination may include a visual component shown on the one or more gaming devices to generate anticipation for the group play game event.

### FIELD OF THE INVENTION

This disclosure relates generally to games, and more particularly to systems, apparatuses and methods for operating an eligibility routine for group play on a plurality of gaming devices.

### BACKGROUND

Casino games such as poker, slots, and craps have long been enjoyed as a means of entertainment. Almost any game of chance that can be played using traditional apparatus (e.g., cards, dice) can be simulated on a computer. The popularity of casino gambling with wagering continues to increase, as does recreational gambling such as non-wagering computer game gambling. It is also likely that most new games will be implemented, at least in part, using computerized apparatus.

One reason that casino games are widely implemented on computerized apparatus is that computerized games are highly adaptable, easily configurable and re-configurable, and require minimal supervision to operate. For example, the graphics and sounds included in such games can be easily modified to reflect popular subjects, such as movies and television shows.

Computer gaming devices can also be easily adapted to provide entirely new games of chance that might be difficult to implement using mechanical or discrete electronic circuits. Because of the ubiquity of computerized gaming machines, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill. In some jurisdictions, the absence of skill when determining awards during game play is a requirement.

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, embodiments of the present invention are directed to an apparatus, system, computer readable storage media, and/or method that involve or otherwise facilitate implementing an eligibility routine for group play involving one or more gaming devices. This routine includes making at least two distinct determinations regarding trigger conditions that need to be met before proceeding to a group play game event, such as a community bonus. A first determination is made to eliminate a number of triggering opportunities without interrupting game play of one or more primary base games being played on the gaming devices. A second determination is made when conditions relating to the first determination are satisfied. The second determination may include a visual component shown on the one or more gaming devices to generate anticipation for the group play game event.

In one embodiment, a gaming apparatus includes a player interface, a display device and a processor. The processor is configured to receive a bet signal associated with a wager being placed on a primary gaming event and transmit an eligibility signal in response to the received bet signal indicating an aspect of the bet signal to a group-play processor. The processor is further configured to receive a widget-triggering signal including outcome information for a widget game event, determine a stopping point in the primary gaming event, and initiate the widget game event on the display device when the determined stopping point in the primary gaming event is reached. After completion of the widget gaming event, the processor may return to the primary gaming event when the received outcome information for the widget game event includes a non-triggering outcome, or initiate a group-play bonus event when the received outcome information for the widget game event includes a triggering outcome.

### BRIEF DESCRIPTION OF THE DRAWINGS

FIG. 1 is a diagram of a gaming system including a detailed diagram of a gaming device according to embodiments of the invention.

FIG. 2 is a detailed diagram of secondary display of the gaming device detailed in FIG. 1 showing an example widget game associated with a group play trigger routine according to embodiments of the invention.

FIGS. 3A, 3B, 3C, and 3D are diagrams of secondary displays showing other example widget game associated with group play trigger routines according to embodiments of the invention.

FIG. 4 is a flow diagram of an eligibility routine for group play of a gaming apparatus according to embodiments of the invention.

FIG. 5 is a flow diagram of an eligibility loading phase for routines associated with group play according to embodiment of the invention.

FIG. 6 is a block diagram of an eligibility storage system for routines associated with group play according to embodiments of the invention.

FIG. 7 is a flow diagram of a trigger determination phase for routines associated with group play according to embodiments of the invention.

FIG. 8 is a block diagram illustrating a computing arrangement according to embodiments of the invention.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the term “reels,” “cards,” “decks,” and similar mechanically descriptive language may be used to describe various apparatus presentation features, as well as various actions occurring to those object (e.g., “spin,” “draw,” “hold,” “bet”). Although the present disclosure may be applicable to manual, mechanical, and computerized embodiments, and any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for eligibility routines associated with group play. Although these eligibility routines are described herein for applications associated with group play or community bonuses, aspects of these routines can be implemented in stand-alone gaming device embodiments to determine eligibility for bonuses or other secondary promotions associated only with a single stand-alone gaming device. As used herein, the term “group play” refers to two or more independent games having a bonus or other game event that involves both games. In some embodiments, the independent games are played on separate gaming apparatuses, which may be connected to each other via a network or other connection means. In other embodiments, the independent games may be played on separate gaming stations on a single gaming apparatus. As used herein, the term “gaming device” may refer to a stand-alone gaming apparatus, a gaming station on multi-person gaming apparatus, or any other type of device that may be used to place wagers on games of chance. Many different implementation and connection schemes are known and/or possible, each falling within the scope of this invention.

Group play is often implemented as a “community bonus,” where play on independent base games can be suspended temporarily to join a group-play gaming or bonus event. Here, gaming devices that are used to play the independent base games are connected to one another via a network or other connection system so that each gaming device can participate in the group play event.

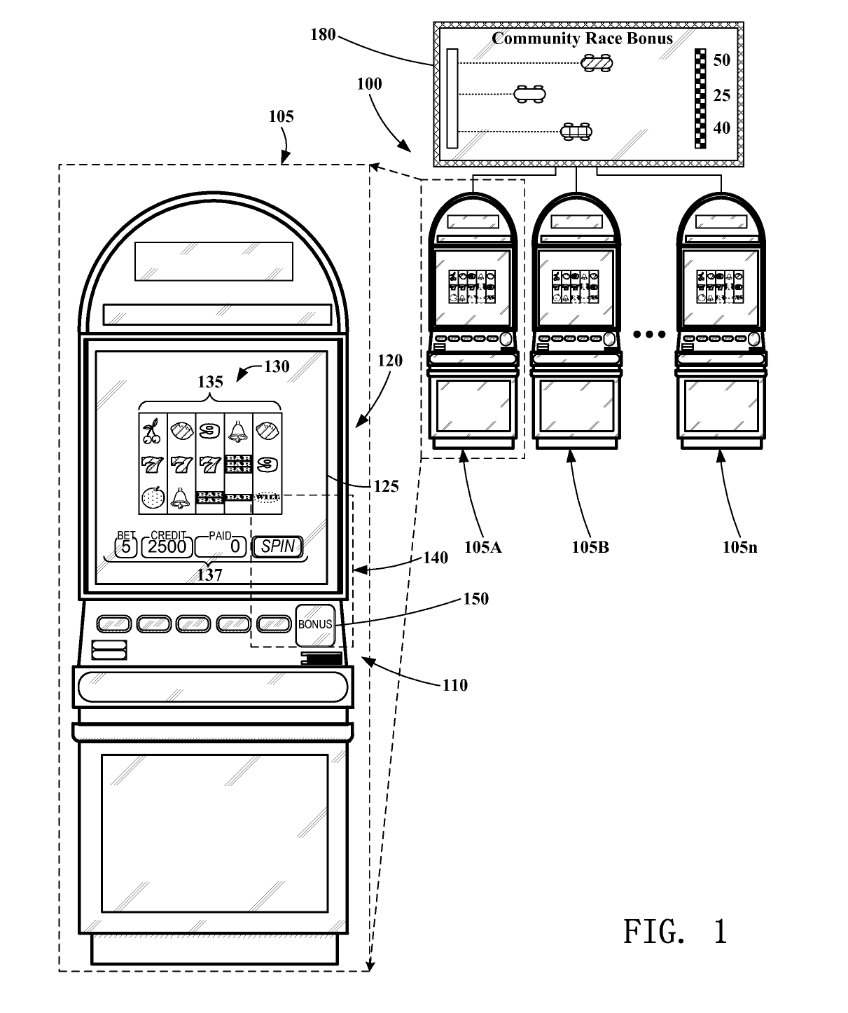

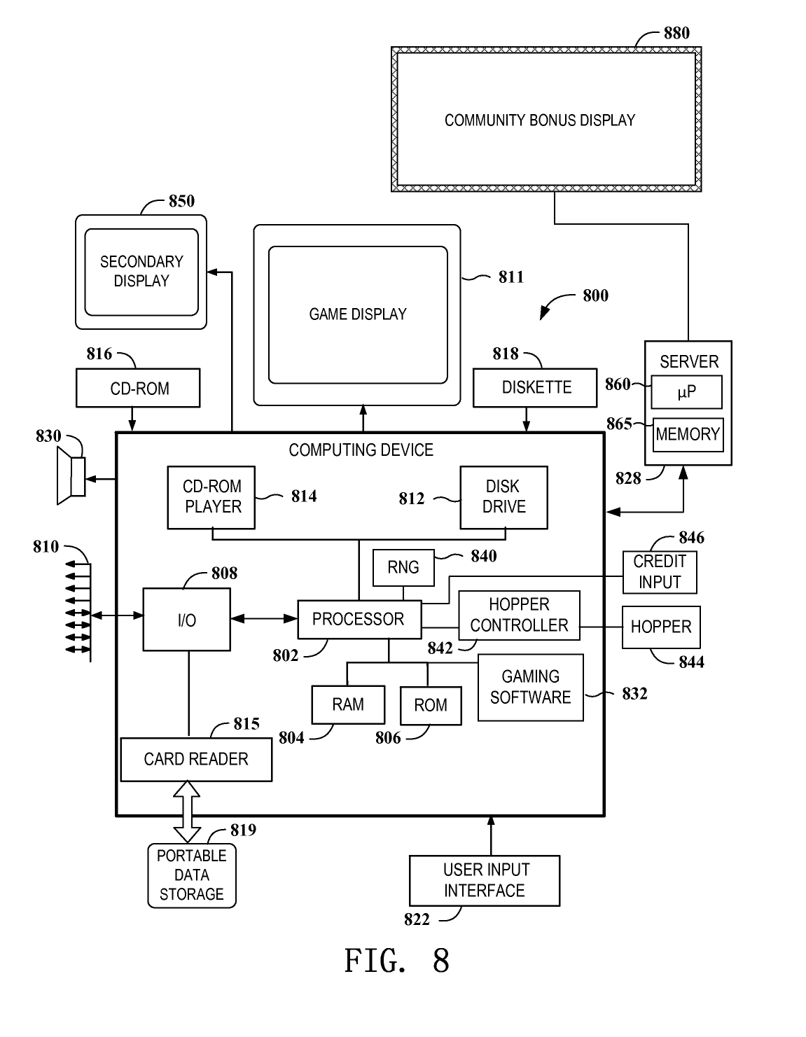

A representative embodiment for a gaming system having a group-play feature is shown in FIG. 1. In this embodiment, a gaming system 100 includes multiple gaming devices 105A, 105B, 105n and a community display 180. The gaming system 100 may also include a central processor, computer, or server (see e.g., element 828 in FIG. 8) that controls operation of a group-play bonus event and/or eligibility of the gaming devices 105A, 105B, 105n to participate in the group-play bonus event. In other embodiments, one or more of the game processors (see e.g., element 802 in FIG. 8) from one or more of the gaming devices 105A, 105B, 105n may control the group-play bonus event and/or determining eligibility of an associated gaming device for play in a group-play bonus event. In FIG. 1, each gaming device 105A, 105B, 105n is shown as a stand-alone gaming apparatus. However, in other embodiments, each of the gaming devices may be a separate gaming station housed in a common gaming apparatus, such as a two seat, three seat, or five seat multi-player gaming apparatus. Many different housing configurations and structures are possible to facilitate aspects of group-play among gaming devices, each of which falls within the scope of this concept.

The community display 180 may include a video display or mechanical display that is viewable from each gaming device 105A, 105B, 105n associated with the gaming system 100. The community display 180 may be used to display group-play or community events during a group-play bonus, or may be used to provide player statistics, game attract screens, or various other information or graphics.

A close up of one of the gaming devices 105A is shown as gaming apparatus 105 to illustrate features of an example gaming apparatus. Here, the gaming apparatus 105 includes a display portion 120 (also referred to as a gaming display), and a player interface portion 110, although some or all of the user interface 110 may be provided via the display 120 in touch screen embodiments. Additionally, a secondary display 150 may be included in the gaming apparatus 105. The display portion 120 may include one or more display areas 125 that may be included in physically separate displays or as portions of a common large display. Here, the game display 125 includes a game play portion 130 that displays game elements and symbols 135, and an operations portion 137 that can include meters, various game buttons, or other game information for a player of the gaming device 105.

The user interface 110 allows the user to control and engage in play of the gaming machine 105. The particular user interface mechanisms included with user interface 110 may be dependent on the type of gaming device. For example, the user interface 110 may include one or more buttons, switches, joysticks, levers, pull-down handles, trackballs, voice-activated input, or any other user input system or mechanism that allows the user to play the particular gaming activity.

The user interface 110 may allow the user or player to enter coins, bills, or otherwise obtain credits through vouchers, tokens, credit cards, tickets, etc. Various mechanisms for entering such vouchers, tokens, credit cards, coins, tickets, etc. are known in the art. For example, coin/symbol input mechanisms, card readers, credit card readers, smart card readers, punch card readers, radio frequency identifier (RFID) readers, and other mechanisms may be used to enter wagers. It is through the user interface 110 that the player can initiate and engage in gaming activities. While the illustrated embodiment depicts various buttons for the user interface 110, it should be recognized that a wide variety of user interface options are available for use in connection with the present invention, including pressing buttons, touching a segment of a touch-screen, entering text, entering voice commands, or other known data entry methodology.

The display device 120 may include one or more of an electronic display, a mechanical display, and a fixed display information, such as paytable information associated with a glass/plastic panel on the gaming machine 105. The symbols or other indicia associated with the play of the game may be presented on an electronic display device or on mechanical devices associated with a mechanical display. Generally, the display 120 devotes the largest portion of viewable area to the primary gaming portion 125. The gaming portion 125 is generally where the visual feedback for any selected game is provided to the user. The gaming portion 125 may render graphical objects such as cards, slot reels, dice, animated characters, and any other gaming visual known in the art. The gaming portion 125 also typically informs players of the outcome of any particular event, including whether the event resulted in a win or loss.

In some the example embodiments illustrated herein, the gaming portion 125 may display multiple game reels 130 on a game grid 135 that shows some of the symbols of the game reels. In other embodiments, playing cards for poker games or other types of gaming indicia may be used in the game play area 130 to facilitate play on a primary or base game. The gaming portion 125 may include other features known in the art that facilitate gaming, such as status and control portion 137. As is generally known in the art, this portion 137 provides information about current bets, current wins, remaining credits, etc. associated with gaming activities of the grid 135. The control portion 137 may also provide touchscreen controls for facilitating game play. The gaming portion 125 of the display 120 may include other features that are not shown, such as paytables, navigation controls, etc.

The secondary display 150 can be used to show a widget used in part to show eligibility for a group-play game or bonus event. As used herein, the term “widget” is used to describe a visual display to a player of a symbol, game, animation, or other indicia that are used to indicate, in part, eligibility for a group-play game or bonus event. By displaying the widget at select times, a player's anticipation of being close to a group-bonus event can be used to enhance the entertainment provided by the gaming system 100. Embodiments of this concept use a multi-part determination to ascertain whether a group-play game or bonus event is triggered as part of an eligibility routine. In a first part of the determination, a first condition must be satisfied to proceed to a second part of the determination. Here, the first part of the determination may happen frequently, such as at small time intervals, but be undetectable to the player of the gaming devices 105A, 105B, 105n so as to not constantly interrupt or distract them from play of their respective primary games on the gaming devices. In alternative embodiments, the first part of the determination process may be evident to players of the gaming system 100 through a visual and/or audio cue. These visual and/or audio cues may be configured to not interrupt game play, but notify a player that a group-play game or bonus event opportunity has occurred. When the first condition is satisfied, however, the second determination may be made in conjunction with displaying the widget to the player to pique their interest and generate anticipation for the group-play game or bonus event. Here, the second determination and related widget display may not always result in the triggering of the group-play game or bonus event, but it can provide the player with increased entertainment instead of conventional methods that are all or nothing triggering propositions for players.

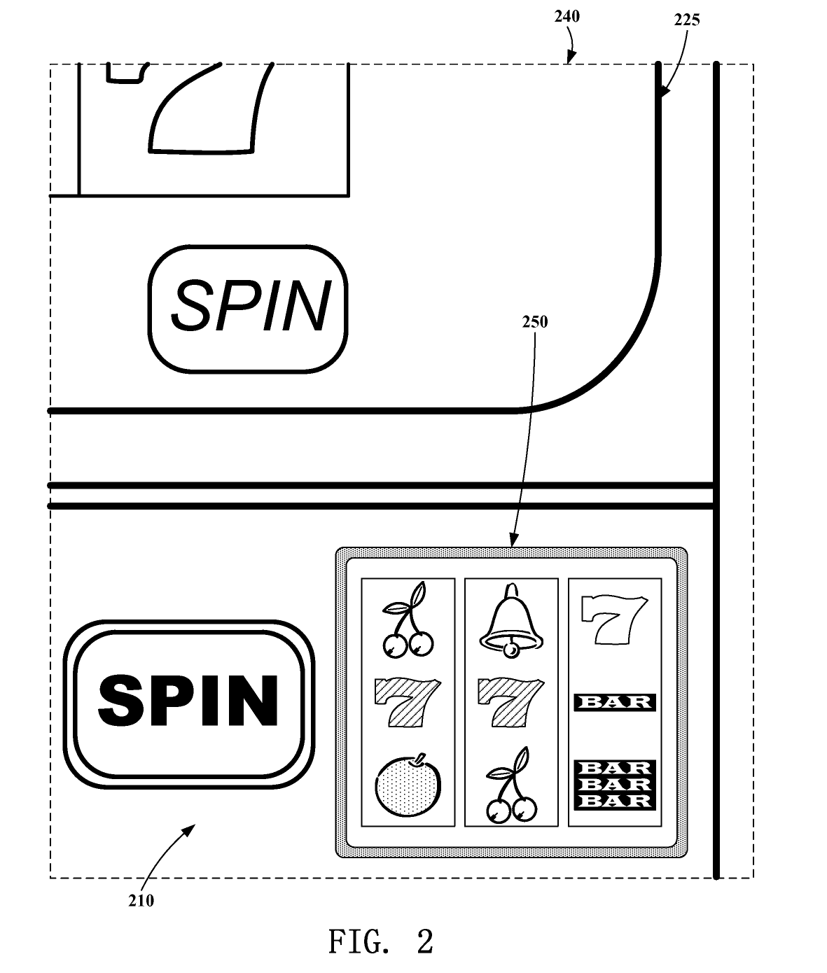

Additional details regarding the widgets, the multi-part determinations, and the eligibility routines are discussed below with reference to FIGS. 2-8. Although, the gaming apparatus 105 is shown in FIG. 1 as having a secondary display 150 to display a widget, the widget may be displayed on a portion of the game display 120 in other embodiments. Thus, in some embodiments, the gaming apparatus 105 may not include a secondary display 150. For purposes of understanding and simplicity, however, embodiments having the widget displayed on a secondary display 150 are described below.

FIG. 2 is a detailed diagram of the secondary display 150 of the gaming device outlined in box section 140 of FIG. 1 showing an example widget game associated with a group play trigger routine according to embodiments of the invention. Referring to FIG. 2, the boxed section 240 of the gaming apparatus 105 of FIG. 1 illustrates a portion of the game display 225 and player interface 210, along with secondary display 250 showing an example widget. In this embodiment, the widget is represented as a three-reel slot game. Here, a predefined symbol combination may correspond to the triggering of a group-play game or bonus event. For example, three bonus symbols may correspond to the triggering of the group-play event, or three like ones of any symbol appearing in the middle position of each reel.

In some embodiments, the outcome of the widget is predetermined by a second part of the determination process. That is, the outcome of the slot widget is determined entirely by the second part of the determination process. For example, if the second determination process is a random draw between 1 and 100 with numbers 90-100 triggering the group-play event, the widget may spin to display three bonus symbols in the middle positions of the reels when the random draw results in a number between 90 and 100. The remaining numbers may correspond to specific non-triggering outcomes for the widget, or the widget may just be randomly spun to a non-triggering outcome (i.e., any outcome except three bonus symbols in the middle position of the reels).

In other embodiments, the outcome of the widget may correspond directly with the triggering of the group-play event where the widget outcome is a portion of the second part of the trigger determination process. For example, stops may be randomly selected for each of the three reels and a resulting symbol combination may be evaluated to determine if it is a triggering outcome.

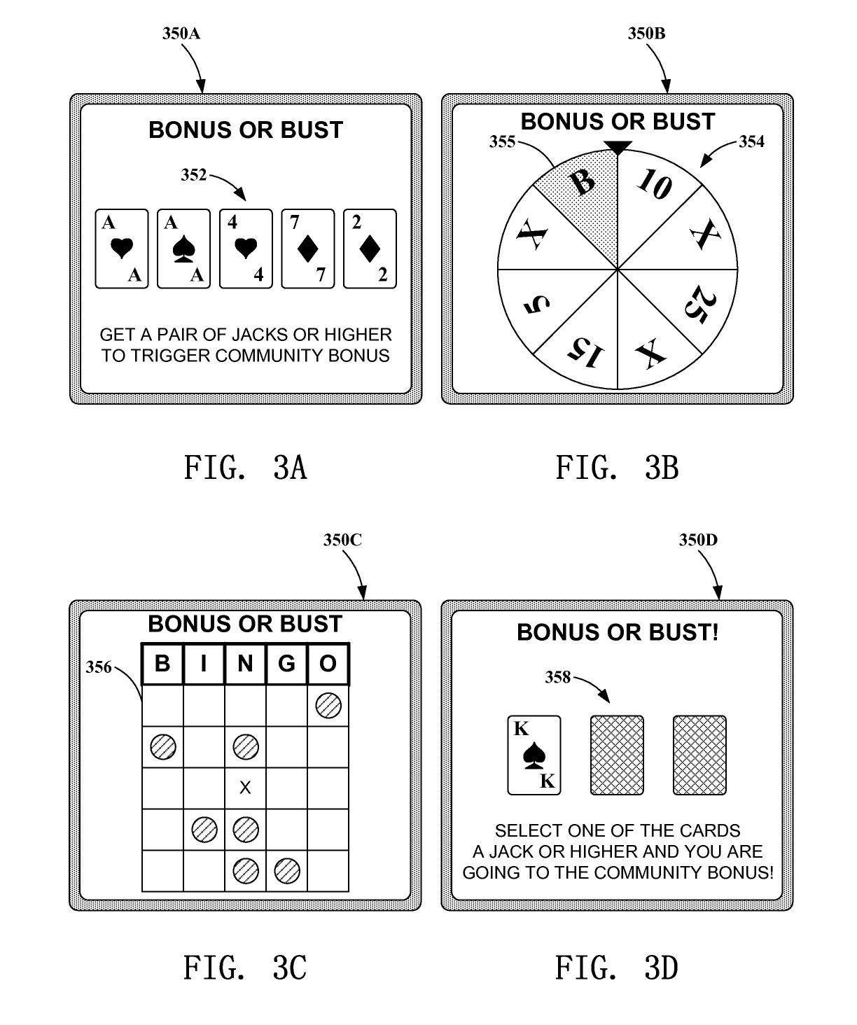

Although a three-reel slot game is shown as a widget in FIG. 2, other embodiments can use any type of game, image, animation, or other indicia in displaying the widget. FIGS. 3A, 3B, 3C, and 3D are diagrams of secondary displays showing other example widget games associated with group play trigger routines according to embodiments of the invention. In FIG. 3A, a display 350A shows a poker game 352 as a widget. Here, receiving a pair of jacks or better corresponds to the triggering of a group-play bonus event. The poker hand may be a stud poker hand or a draw poker hand, and may use any number of cards to create the widget poker hand. The poker hand may be selected based on the result of the second part of the triggering determination, or the second part of the triggering determination may depend on the result of the poker widget hand.

In FIG. 3B, a display 350B shows a widget wheel 354 with a variety of indicia on sections of the wheel. Here, a special bonus section 355 of the widget wheel 354 may correspond to the triggering of a group-play game or bonus event. In some embodiments, the other sections of the widget wheel 354 may have no impact or bearing on the play of the gaming device. In other embodiments, however, some or all of the other sections of the widget wheel may have awards, multipliers, or other indicia that affects or modifies game play on the gaming event. In the embodiment shown in FIG. 3B, some of the sections of the widget wheel 354 include consolation credit awards, while other sections of the widget wheels have “X” symbols that signify that nothing is awarded when such a selection is indicated in a widget game. Again, which section of the widget wheel 354 is selected can be determined entirely by the second part of the triggering determination, or may instead act as a portion of the second part of the triggering determination.

In FIG. 3C, a display 350C shows a widget BINGO game, where five marks on the BINGO board in a row, column, or diagonal corresponds to the triggering of a group-play game or bonus event. In the BINGO widget game 356, the widget can be played such that a number of marks appear on the BINGO board simultaneously or in rapid succession to show whether a group-play event has been triggered. In alternate embodiments, however, the BINGO widget 356 can have an element of persistence. That is, the BINGO board may maintain its state between widget games, where one or more additional marks are added to the BINGO board during each widget game until a group-play game or bonus event is triggered. Here, a player may have an incentive to continue playing a gaming device if a widget BINGO game 356 is getting close to having five marks in a row, column, or diagonal. Embodiments using a persistence element can also be applied to a variety of widget games, animations, or images other than BINGO.

In FIG. 3D, a display 350D shows a widget card game 358 where a player has some interaction with the widget. In this example, a player selects one of three face-down cards. The selected card is revealed and corresponds to the triggering of a group-play game or bonus event when it is a jack or higher. Again, the result of the widget card game 358 may be controlled entirely by the second part of the determination process, or have some part of effect in the second part of the determination process. For example, if the widget card game 358 is controlled by the second part of the determination process, the card selected by the player, regardless of which card is selected, would correspond to a card value associated with a triggering condition or a non-triggering condition. In other embodiments, the cards placed on the screen to be selected may be determined by the triggering condition determined in the second part of the triggering determination. For example, if the second part of the triggering condition resulted in a triggering condition being satisfied, all of the cards placed on the widget screen may be a jack or higher. In yet other embodiments, the selection process may have some bearing on the triggering condition itself in the second part of the triggering determination. For example, the second part of the triggering determination may be broken up into a third and fourth determination, where the third determination is used to select the number of triggering cards to place in the widget card game 358 (either zero, one, two, or three), and the fourth determination is used to see which card is selected. Note that in the cases of the zero or three triggering cards being placed in the widget card game 358, the actual card selected (and hence the fourth determination itself) is irrelevant to the whether the group-play game or bonus event is triggered.

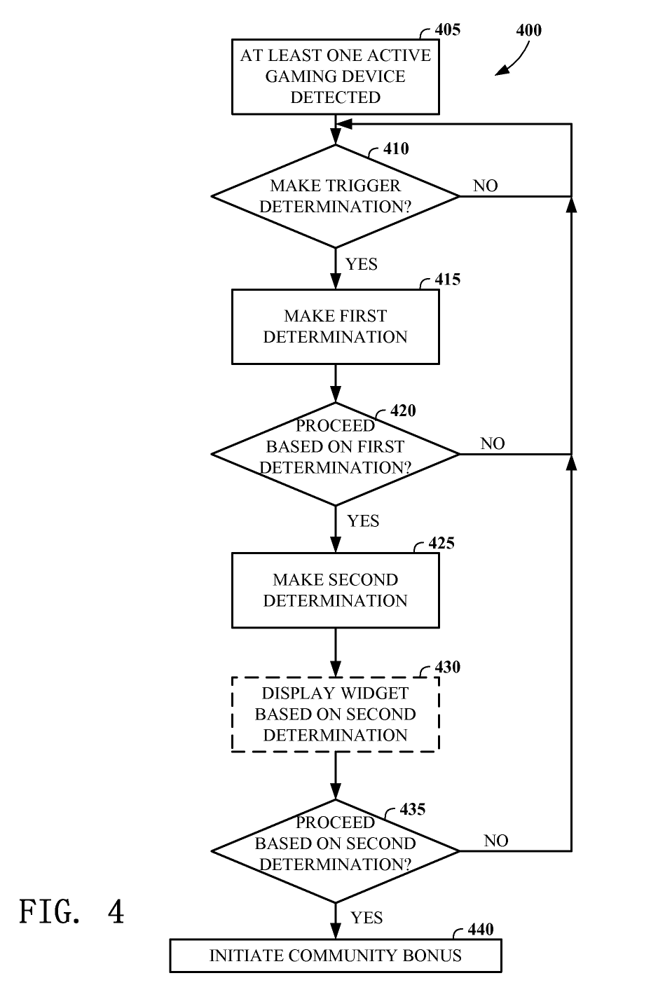

FIG. 4 is a flow diagram of an eligibility routine for group play of a gaming apparatus according to embodiments of the invention. Although various processes are shown in a particular order in this flow diagram, the order of these processes can be changed in other embodiments without deviating from the scope or spirit of this concept. Hence, the order of the processes shown is for illustrative purposes only and is not meant to be restrictive. Additional game processes may also be included between various processes even though they are omitted from these flow diagrams for clarity purposes. Further each of the processes may be performed by components in a single game device, such as by a game processor, or may be performed in part or whole by a remote server or processor connected to the gaming device via a network. Each process may be encoded in instructions that are stored in a memory, a computer-readable medium, or another type of storage device. Note that this example method is just one embodiment of how a game operation can be implemented. As discussed and shown above, many variations exist which may require additional, fewer, or different processes to complete.

Referring to FIG. 4, a flow 400 begins at process 405 where it is determined that at least one active gaming device is detected. Here, gaming devices may have to be played at a predetermined coin-in rate to be considered “active” and eligible for a group-play bonus. This coin-in rate may take into account the size of wagers being placed and/or the frequency at which they are placed. There are various methods in measuring and monitoring this coin-in rate metric. In one example, each wager “buys” a number of “evaluations” that are stored and used up periodically while the gaming device is being played. In another embodiment, all gaming devices that have had a wager placed in a past set time frame (e.g., 30 seconds) are eligible for a group-play bonus event.

After it has been determined that at least one active gaming device has been detected in process 405, the flow 400 proceeds to process 410, where a processor decides whether or not to make a triggering determination for a group-play game or bonus event. This decision may be based on a variety of factors. In some embodiments, a trigger determination is made at predefined time intervals. For example, if a trigger determination is made every half second (0.5 sec), a processor would wait until the next time interval had elapsed before proceeding through process 410. In other embodiments the triggering determination may be based on an outcome of a primary game event, on a timing condition associated with the primary game event, on an incrementing counter reaching a predefined threshold, or various other possible metrics.

Once the triggering determination is made, the flow proceeds to process 415 where a first determination is made. Above, the overall triggering determination for a group-play game or event was described as having a first part and at least a second part. In this flow diagram and description the first determination in process 415 may correspond to the first part of the triggering determination described above, and the second determination in process 425 may correspond to the second part of the triggering determination described above. Returning to the embodiment described in FIG. 4, the first determination 415 may be a preliminary determination that is not detectable to a player at a gaming device so as to not constantly interrupt their game play on the primary game of the gaming device. In the above example where a triggering determination is made every half second, a player may be overwhelmed if they were aware of each first determination being made. The first determination process 415 may include making a random draw, incrementing a counter, updating a bonus clock, determining if a predefined condition has occurred in the base game, or making another type of determination.

In process 415, a decision is made on whether to proceed to a second determination process 425 based on the result of the first determination process 415. In the above example first determinations, a random draw may be compared to a threshold value or group of values to proceed, a counter may be analyzed to see if it has reached a triggering threshold, a bonus clock may be evaluated to see if it has reached a triggering time, a base game outcome may be analyzed to see if a predetermined symbol or symbol combination has occurred, or another type of triggering metric may be used to see of the first determination has resulted in an outcome that moves the flow 400 to the second determination in process 425. If the first determination does not result in a proceeding outcome, flow 400 returns to process 410 to wait for another opportunity to make a triggering determination.

When the flow 400 does proceed to process 425, a second determination is made. As with the first determination, the second determination may involve a number of different determination processes. However, unlike the first determination process, the second determination process may be detectable to a player to increase anticipation of a group-play game or bonus event. This may include displaying a widget based on the second determination as shown in optional process 430. As described above, the second determination can be made prior to display of the widget where the widget outcome is directly controlled by the outcome of the second determination in process 425, or the second determination can include an outcome of the widget, which may include player interaction. The second determination can also include a random draw, an incrementing counter, an updated clock, a predetermined condition occurring on a primary game, or other types of determination techniques.

Once the second determination has been made, the flow proceeds to process 435 where it is determined whether to proceed with the group-play triggering process. If the second determination does not result in an outcome associated with a triggering condition, flow 400 returns to process 405 to wait for another opportunity to make a triggering determination. If the second determination does result in an outcome associated with a triggering condition, flow 400 proceeds to process 440 where a group-play or community game/bonus is initiated.

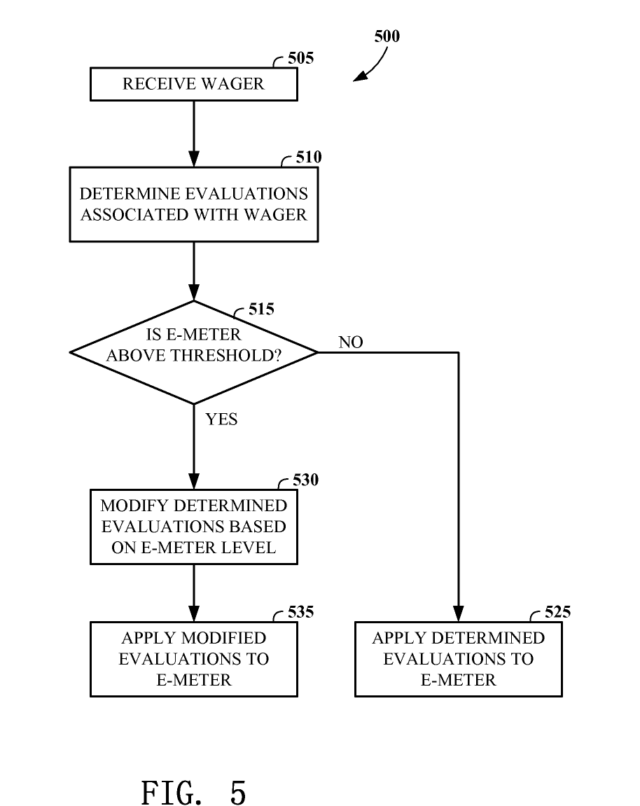

FIGS. 5, 6, and 7 are provided to illustrate example embodiments about how these first and second determinations can be made within the eligibility routines needed for group play. These illustrated embodiments include a loading phase for a gaming device to be eligible for a group-play game or bonus event, and a trigger determination phase using the results of the loading phase to determine if a group-play game or bonus-event is triggered.

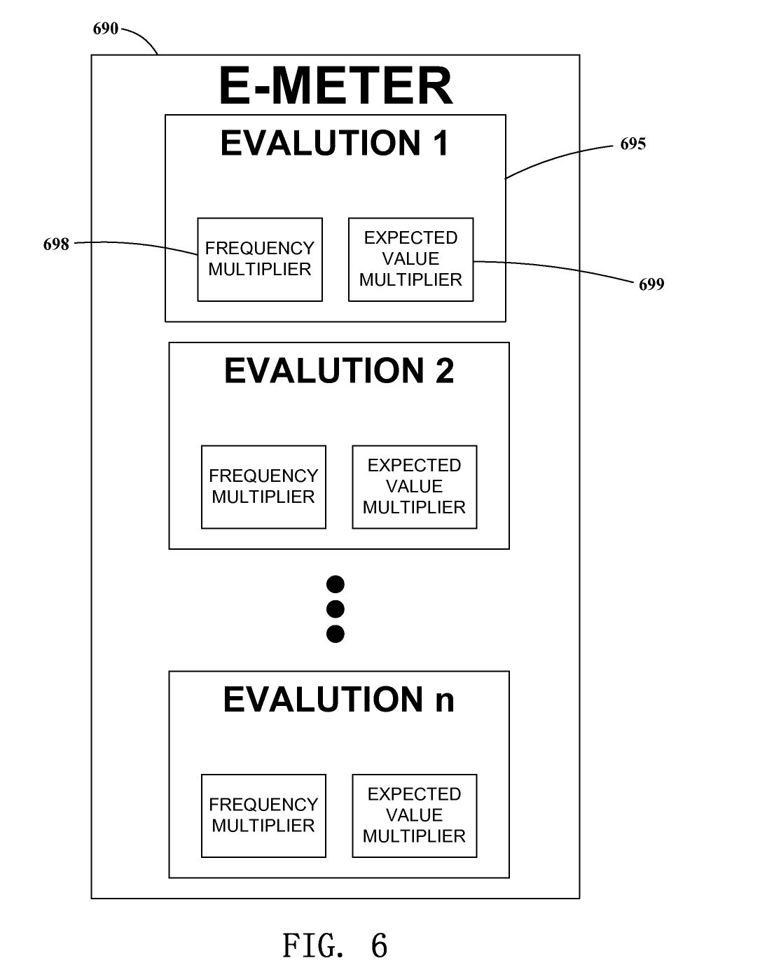

FIG. 5 is a flow diagram of an eligibility loading phase for routines associated with group play according to embodiment of the invention. Referring to FIG. 5, a flow 500 begins at process 505 where a wager is received. Here, this process 505 may include receiving a signal that a wager has been entered and a game initiation button or mechanism has been activated to place the wager and initiate a primary or base game. In process 510 evaluations associated with the received wager are determined. Here, “evaluations” refer to eligibility opportunities. Evaluations may be electronic data stored in a memory, a register, a meter, or any other type of data structure. In these embodiments, the evaluations are stored in an eligibility meter (or “E-Meter”), which is discussed in more detail below with respect to FIG. 6.

The number of evaluations received with a wager may be a function of the amount of the wager, where the function may direct a proportional amount of evaluations to be given for wager amounts. In other embodiments, the number of evaluations may be determined in part by other game metrics, such as rate of play, whether the player is an identified casino loyalty club member, the result of the last “n” number of games, or other game metrics. In one example, a player is awarded 20 evaluations for every dollar wagered. Thus, a $2.00 bet will result in 40 evaluations being determined in process 510. The determination process 510 may be a preliminary determination process, as the flow 500 then proceeds to process 515 where it is determined if the eligibility meter is above a predefined threshold. In one example, a player is awarded 20 evaluations for every dollar wagered. Thus, a $2.00 bet will result in 40 evaluations being determined in process 510.

Here, the eligibility meter may have a threshold value where instead of just adding more evaluations (eligibility opportunities) for players playing with larger wagers and/or at a very rapid pace, these players are rewarded by receiving more valuable evaluations. As described below, in some embodiments, evaluations can be associated with one or more multiplier or modifier values that increase the probability that a group-play game or bonus event is triggered and/or increase values won within the group-play event. In these embodiments, flow 500 proceeds to process 525 when the eligibility meter is not above a threshold value, where the determined evaluations are added to the eligibility meter. Alternatively, if the eligibility meter is determined to be at a threshold value in process 515, flow 500 proceeds to process 530, where the determined evaluations are modified based on the eligibility meter level. The evaluation modification in process 530 may include associating the awarded evaluations with a multiplier or other modifier. The number of evaluations awarded may also be modified in process 530. In the above example where 20 evaluations are distributed for each dollar wagered, a $2.00 wager made when the eligibility meter is above a first threshold may result in only 10 evaluations being awarded, but each evaluation is given a “5×” frequency multiplier and a “2×” expected value multiplier. The function of these multipliers is discussed below in more detail, but any type of multiplier or modifier may be associated with the distributed evaluations. After the evaluations are modified in process 530, flow 500 proceeds to process 535 where the modified evaluations are applied to the eligibility meter.

FIG. 6 is a block diagram of an eligibility storage system for routines associated with group play according to embodiments of the invention. Referring to FIG. 6, an eligibility meter or E-Meter 690 is illustrated in block form. In gaming system embodiments, each gaming device may be associated with its own eligibility meter 690, or a collective eligibility meter may be used to track evaluations for each associated gaming device in the gaming system. An eligibility meter may be stored within the memory on a gaming device, or in a central memory located in a remote server or other central computing arrangement. Eligibility meters may be any type of data structure including counters, booleans, arrays, records, lists, sets, matrices, stacks, strings, graphs, etc. In some embodiments, eligibility meters 690 include stored evaluations 695, which may each have an associated frequency multiplier 698 and an expected value multiplier 699. In other embodiments, each evaluation may not have any multipliers or modifier values associated with it. The frequency multiplier 698 and expected value multiplier 699 may have a default value of “1” so that they do not provide any influence in a default state. The frequency multiplier 698 may affect one or more of the determination processes in a multi-step group-play trigger determination. For example, in a second determination step (such as 425 in FIG. 4), a random draw may be completed where the frequency of success is equal to a product of a base value multiplied by sum of the frequency multipliers of all current evaluations being deducted or used. That is, in a three player gaming system, if all players are playing with high denomination wagers and/or playing at a rapid play pace, frequency multipliers awarded to each of their accumulated evaluations may make the likelihood of a community bonus being triggered to increase dramatically. If the base value is equal to a value of 2 for each eligible game device and a frequency multiplier 698 of “5×” is associated with each of the evaluations 695 being awarded, the likelihood of a community bonus is 15 times greater than if the three players were playing at a slower rate and/or at a lower denomination. Additionally, the frequency multiplier 698 and expected value multiplier 699 may be used to alter values within a group-play bonus or a final payout of a community bonus.

Eligibility meters 690 may work in a various methods to store and retrieve evaluations 695. In some embodiments, E-Meters 690 have a stack structure where newly acquired evaluations 695 are pushed on the stack, and used or deducted evaluations are retrieved according to a known stack system, such as FILO (First In Last Out) or FIFO (First In First Out). When evaluations 695 include multiplier values or other modifiers, a FILO stack system may be preferred so that recently received evaluations with improved multiplier or modifier values can be immediately used. In other embodiments, a processor may sort the evaluations 695 in the eligibility meter 690 according to one or more routines or variables, such as by multiplier or modifier values associated with the evaluations. In an alternative example, each evaluation 695 may be given a priority rating. Here, if a player changes her bet size, the priority rating of newly added evaluations may be given a lower priority rating. Additionally, a sorting function may be applied when a player changes her bet size to re-order evaluations 695 in the eligibility meter 690 according to priority rating. For example, if a player reduces her bet size, newly added evaluations 695 may be given a lower priority, and sorted to the bottom of the eligibility meter 690.

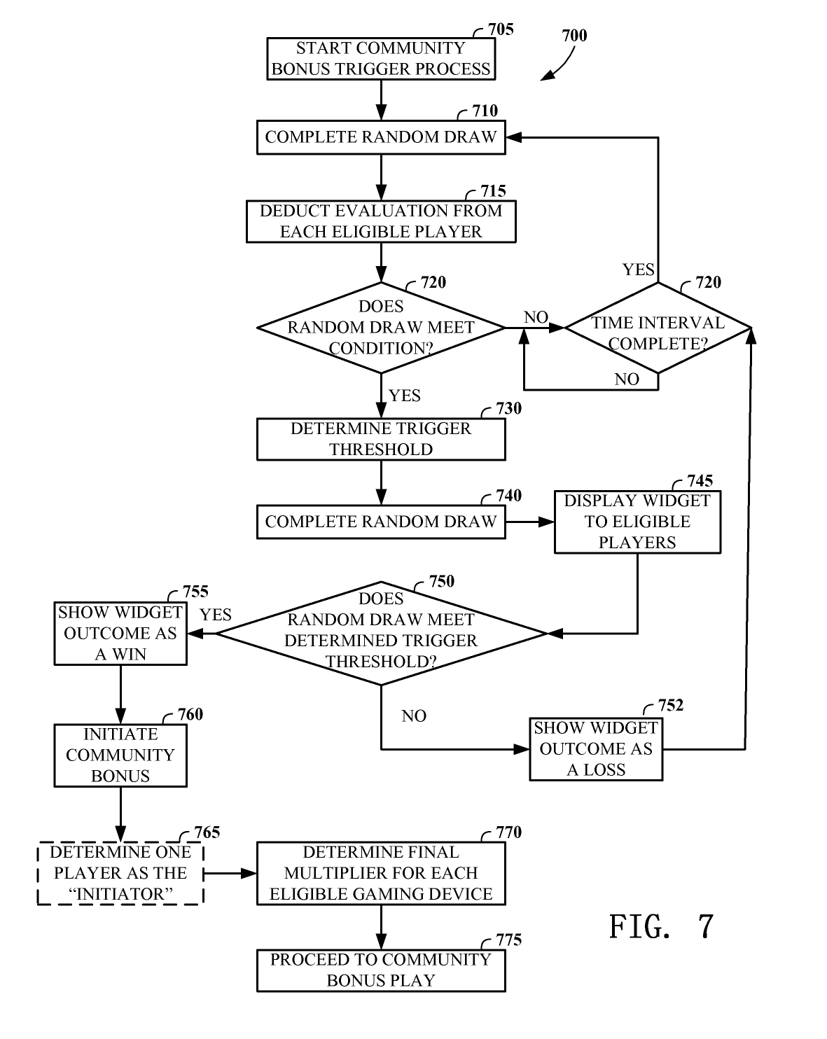

FIG. 7 is a flow diagram of a trigger determination phase for routines associated with group play according to embodiments of the invention. Referring to FIG. 7, a flow 700 begins at process 705 where a community bonus trigger process is initiated or started. A random draw is completed in process 710, which may be part of a first determination process. An evaluation is deducted for each eligible player in process 715, and a determination is made in process 720 to ascertain whether the random draw of process 710 satisfies a predefined condition. If there are multiple gaming devices eligible for the bonus (i.e., multiple gaming devices with at least one evaluation present in an associated eligibility meter), an evaluation from each of the eligible gaming devices is deducted in process 715.

If the first random draw does not meet the predefined condition, flow 700 goes to process 720 where it is determined if a predetermined time interval has elapsed. Once the time interval has elapsed, flow 700 returns to process 710 to complete another random draw. This cycle repeats as long as there is an eligible gaming device until the random draw of process 710 meets the predefined condition in process 720. Note that each wager made provides additional evaluations to an eligibility meter as described above, but these evaluations are deducted, used, or “spent” each time a random draw is made in the first step of the multi-step determination process. Hence, the eligibility of a gaming device for a group-play game or bonus event may be dependent upon it having at least one evaluation present in a related eligibility meter. In some embodiments, a player may have to play at certain rate and at a certain wager amount to be eligible for group-play games or bonuses.

When the random draw of process 710 satisfies the predetermined condition in process 720, flow 700 proceeds to process 730 where a trigger threshold is determined. In process 730, a trigger threshold may be modified by frequency multipliers associated with the last deducted evaluation from process 715, modified based on the number of eligible gaming devices, or otherwise modified based on another condition or metric. The trigger threshold may also be simply determined to be at a default value in process 730. In process 740, a second random draw is completed. This random draw in process 740 may correspond to a second determination process discussed above.

In process 745, a widget is displayed and initiated to players at eligible gaming devices. This widget may be associated with the random draw in process 740 as discussed above. Flow 700 then proceeds to process 750, where it is determined whether the second random draw of process 740 satisfies the trigger threshold determined in process 730. If the second random draw does not meet the triggering threshold, flow 700 proceeds to process 752 where the widget outcome is shown as a loss or non-triggering outcome. Flow 700 then returns to process 720 to complete a time interval before returning to a first random draw in process 710. If the second random draw does satisfy the triggering threshold in process 750, flow 700 proceeds to process 755 where the widget outcome is shown as a win or triggering outcome. Flow 755 may then proceed to process 760 where a group-play or community bonus is initiated.

In optional process 765, one of the eligible gaming devices may be selected as an “initiating” gaming device. That is, one of the players is designated as the “initiator” for the community bonus. In this optional process 765, the initiator may be determined from the result of the second random draw in process 740, or may be selected by a third random draw. In some embodiments, each frequency multiplier, or other modifier, associated with each eligible gaming device may weight the outcome of this random draw. Hence, a player playing at a faster pace or with larger wagers may have a greater chance of being selected as the initiator. The selected initiator may receive an increased final multiplier for any awards received in the group-play bonus event. In addition, providing an “initiator” in optional process 765 provides at least one player with the appearance of triggering the bonus, which can create an agency relationship with the bonus. As mentioned above, in addition to having an agency relationship with the bonus, a selected “initiating” player may be rewarded with a chance to improve on any awards won in the bonus. This feature also can provide the ability to reward players that are playing at a faster rate and/or wagering with higher denomination bets by using variables associated with individual evaluations, such as priority ratings or frequency multipliers, when selecting the “initiating” player.

In process 770, a final multiplier for each eligible game device is determined. As discussed above, an expected value multiplier and/or a frequency multiplier for a deducted evaluation used in a current triggering determination may be used in determining a final multiplier. Additionally, whether a player is an “initiator” may influence a final multiplier value. The final multiplier value may also be influence based on wager amounts or other metrics. The final multiplier may be used to automatically adjust award amounts in a group-play bonus won by a respective player, or may be applied at the end of the group bonus to modify any winnings awarded to the respective player during the group-play bonus. Flow 700 then continues to process 775, where the group-play or community bonus event proceeds.

Thus with respect to the embodiments shown in FIGS. 5-7, a gaming system is presented where each bet or wager made on a gaming device purchases a certain number of evaluations. Unlike conventional triggering processes, eligibility routines using this present concept may include multidimensional evaluations, which can enable more sophisticated or complex responses to gaming conditions by using additional variables associated with the multidimensional evaluations. For example, each evaluation may have two associated quantities, a “frequency multiplier” and an “expected value multiplier,” each with a default value of 1. Purchased evaluations accumulate until they approach a certain maximum, at which point each bet purchases a smaller number of evaluations with higher frequency multipliers and/or expected value multipliers. A player is eligible for the community feature if they have one or more accumulated evaluations.

To initiate the feature, a central computer carries out a two-step decision repeatedly at small time intervals. In the first step, the computer decides whether to proceed to the second step. This decision is made by random draw with a constant probability of success. When the decision is made, the computer deducts one evaluation from each eligible player.

In the second step, the computer makes a random draw, with frequency of success equal to the product of a base value (e.g., determined by the number of eligible players) times the sum of the frequency multipliers of all current evaluations. If the random draw succeeds, then the feature is initiated. Upon feature initiation, the computer determines each participant's final pay multiplier, taking into account both the frequency multiplier and the expected value multiplier for each participant.

In some embodiments, when the feature is initiated, the computer chooses one player to be the “initiator” of the feature. This choice is made by random draw, weighted according to each player's frequency multiplier value. The “initiator” player is awarded an increased pay multiplier for the feature. Other random draws that increase or decrease pay multipliers may be involved in producing the required expected pay values.

The present invention provides a number of advantages over conventional methods of determining eligibility for a group-play gaming event including an unambiguous eligibility period, determined at all times by the number of evaluations remaining. Also, when other players join the bank or game system, there are no disabled symbols or other signs of reduced initiation frequency. Although an individual player may in fact experience a reduced initiation frequency when new players with low bet speed join the bank, the present invention enables game designers to set a minimum initiation frequency in all cases. Moreover, the individual player can positively affect the initiation frequency (and, in one embodiment, experience the benefit of being the “initiator” more often) by betting more quickly.

As may now be readily understood, one or more devices may be programmed to play various embodiments of the invention. The present invention may be implemented as a casino gaming system or other special purpose gaming kiosk as described hereinabove, or may be implemented via computing systems operating under the direction of local gaming software, and/or remotely-provided software such as provided by an application service provider (ASP). The casino gaming machines utilize computing systems to control and manage the gaming activity. An example of a representative computing system capable of carrying out operations in accordance with the invention is illustrated in FIG. 8.

Hardware, firmware, software or a combination thereof may be used to perform the various gaming functions, display presentations and operations described herein. The functional modules used in connection with the invention may reside in a gaming system having multiple gaming devices as described, or may alternatively reside on a stand-alone gaming apparatus or a networked computer. The computing structure 800 of FIG. 8 is an example computing structure that can be used in connection with such electronic gaming system, gaming machines, computers, or other computer-implemented devices to carry out operations of the present invention.

The example computing arrangement 800 suitable for performing the gaming functions in accordance with the present invention typically includes a central processor (CPU) 802 coupled to random access memory (RAM) 804 and some variation of read-only memory (ROM) 806. The ROM 806 may also represent other types of storage media to store programs, such as programmable ROM (PROM), erasable PROM (EPROM), etc. The processor 802 may communicate with other internal and external components through input/output (I/O) circuitry 808 and bussing 810, to provide control signals, communication signals, and the like.

The computing arrangement 800 may also include one or more data storage devices, including hard and floppy disk drives 812, CD-ROM drives 814, card reader 815, and other hardware capable of reading and/or storing information such as DVD, etc. In one embodiment, software for carrying out the operations in accordance with the present invention may be stored and distributed on a CD-ROM 816, diskette 818, access card 819, or other form of computer readable media capable of portably storing information. These storage media may be inserted into, and read by, devices such as the CD-ROM drive 814, the disk drive 812, card reader 815, etc. The software may also be transmitted to the computing arrangement 800 via data signals, such as being downloaded electronically via a network, such as the Internet. Further, as previously described, the software for carrying out the functions associated with the present invention may alternatively be stored in internal memory/storage of the computing device 800, such as in the ROM 806.

The computing arrangement 800 is coupled to the game display 811, which represents a display on which the gaming activities in accordance with a primary or base game are presented. Additionally, the game display 811 may display a widget in connection with an eligibility routine for group play as described above in some embodiments. In other embodiments, a secondary display 850 may be used to display the widget in connection with an eligibility routine for group play as described above. The display 811 (and secondary display 850, if included) represents the “presentation” of the video information in accordance with the invention, and may be any type of known display or presentation screen, such as liquid crystal displays, plasma displays, cathode ray tubes (CRT), digital light processing (DLP) displays, liquid crystal on silicon (LCOS) displays, etc.

Where the computing device 800 represents a stand-alone or networked computer, the display 811 may represent a standard computer terminal or display capable of displaying multiple windows, frames, etc. Where the computing device is embedded within an electronic gaming machine, the display 811 corresponds to the display screen of the gaming machine/kiosk. A user input interface 822 such as a mouse, keyboard/keypad, microphone, touch pad, trackball, joystick, touch screen, voice-recognition system, etc. may be provided. The display 811 may also act as a user input device, e.g., where the display 811 is a touchscreen device.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs as known in the art may be implemented using hardware, software operable in connection with the processor 802, or some combination of hardware and software. The present invention is operable using any known RNG, and may be integrally programmed as part of the processor 802 operation, or alternatively may be a separate RNG controller 840.

The computing arrangement 800 may be connected to other computing devices or gaming machines, such as via a network. The computing arrangement 800 may be connected to a network or bank server 828 in an intranet or local network configuration. The computer may further be part of a larger network configuration as in a global area network (GAN) such as the Internet. In such a case, the computer may have access to one or more web servers via the Internet. In other arrangements, the computing arrangement 800 may be configured as an Internet server and software for carrying out the operations in accordance with the present invention may interact with the player via one or more networks. The server 828 may include a memory 865 and a microprocessor 860 to implement the eligibility routines for group play described above. For example, eligibility meters including evaluations may be stored in the server memory 865, and the server processor 860 may act as a central processor to connect one or more gaming devices in a group-play or community bonus event. Multiple other computing arrangements may also be connected to the server 828. In addition, a community bonus display 880 may be connected to the server 828, where the community bonus display is used to display portions of a group-play or community bonus that involves multiple gaming devices. The community bonus display 880 may also be any type of display, such as an LCD, CRT, plasma or similar video display, as well as being a mechanical display using lights or other mechanical features to carry out a group-play bonus.

Other components directed to gaming machine implementations include manners of gaming participant payment, and gaming machine payout. For example, a gaming machine including the computing arrangement 800 may also include a hopper controller 842 to determine the amount of payout to be provided to the participant. The hopper controller may be integrally implemented with the processor 802, or alternatively as a separate hopper controller 842. A hopper 844 may also be provided in gaming machine embodiments, where the hopper serves as the mechanism holding the coins/tokens of the machine. The wager input module 846 represents any mechanism for accepting coins, tokens, coupons, bills, electronic fund transfer (EFT), tickets, credit cards, smart cards, membership cards, etc., for which a participant inputs a wager amount. It will be appreciated that the primary gaming software 832 may be able to control payouts via the hopper 844 and controller 842 for independently determined payout events.

Among other functions, the computing arrangement 800 provides an interactive experience to players via input interface 822 and output devices, such as the display 811, speaker 830, etc. These experiences are generally controlled by gaming software 832 that controls a primary gaming activity of the computing arrangement 800. The gaming software 832 may be temporarily loaded into RAM 804, and may be stored locally using any combination of ROM 806, drives 812, media player 814, or other computer-readable storage media known in the art. The primary gaming software 832 may also be accessed remotely, such as via the server 828 or the Internet.

The primary gaming software 832 in the computing arrangement 800 is shown here as an application software module. According to embodiments of the present invention, this software 832 provides a slot game or similar game of chance as described hereinabove. For example, the software 832 may present, by way of the display 811, representations of symbols to map or otherwise display as part of a slot based game having reels. However, in other embodiments, the principles of this concept may be applied to poker games or other types of games of chance. One or more aligned positions of these game elements may be evaluated to determine awards based on a paytable. The software 832 may include instructions to provide other functionality as known in the art and described herein, such as shown and described above regarding FIGS. 1-7.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A gaming system comprising:
a first gaming device having a primary display for displaying a base game, and a secondary display;
a second gaming device having a primary display for displaying a base game, and a secondary display;
a group display; and
a server connected to the first gaming device, the second gaming device, and the group display, the server including:
a memory configured to store one or more eligibility meters associated with the first and second gaming devices, each eligibility meter configured to store evaluations associated with one of the first gaming device or the second gaming device; and
a processor configured to:
determine if at least one of the first gaming device or the second gaming device is eligible for a group-play bonus by verifying whether at least one evaluation is stored in the one or more eligibility meters in the memory,
complete a first random draw at a predetermined time interval when at least one of the first gaming device or the second gaming device is eligible for a group-play bonus,
deduct an evaluation from the one or more eligibility meters for each of the eligible ones of the first gaming device and the second gaming device,
determine if a result of the first random draw satisfies a predefined condition,
complete a second random draw when the result of the first random draw satisfies the predefined condition,
determine if a result of the second random draw satisfies a trigger threshold,
transmit a signal to each of the eligible ones of the first gaming device and second gaming device to display a widget on the respective secondary displays of the first gaming device and the second gaming devices, the signal further including information regarding an outcome to be displayed for each widget, the outcome associated with the result of the second random draw, and
initiate a group-play bonus that is displayed at least in part on the group display when the result of the second random draw is determined to satisfy the trigger threshold.

2. The gaming system of claim 1, wherein each evaluation stored in the one or more eligibility meters in the memory are associated with a frequency multiplier and an expected value multiplier.

3. The gaming system of claim 2, wherein the processor is further configured to determine the trigger threshold.

4. The gaming system of claim 3, wherein the processor determines the trigger threshold by multiplying an eligibility value based on a number of eligible gaming devices with the sum of the frequency multipliers of the evaluations being deducted for each of the eligible gaming devices.

5. The gaming system of claim 2, wherein the processor is further configured to determine a final multiplier for each eligible gaming device in the group-play bonus, the final multiplier based on the frequency multiplier and the expected value multiplier for each evaluation being deducted for each of the respective eligible gaming devices.

6. The gaming system of claim 5, wherein the processor is further configured to determine one of the eligible gaming devices as an initiating device when the result of the second random draw is determined to satisfy the trigger threshold.

7. The gaming system of claim 6, wherein the processor is configured to determine the initiating device by further analyzing the result of the second random draw, where a result of the second random draw is compared to weighted table of the eligible gaming devices having weightings based on the frequency multipliers associated with each evaluation being deducted for each of the respective eligible gaming devices.

8. The gaming system of claim 6, wherein the processor is further configured to modify the final multiplier for the gaming device determined to be the initiating device.

9. The gaming system of claim 6, wherein the first gaming device and second gaming device are housed in a common gaming apparatus.

10. A gaming apparatus comprising:
a player interface;
a display device; and
a processor configured to:
receive a bet signal associated with a wager being placed on a primary gaming event via the player interface;
transmit an eligibility signal in response to the received bet signal indicating an aspect of the bet signal to a group-play processor;
receive a widget-triggering signal including outcome information for a widget game event;
determine a stopping point in the primary gaming event;
initiate the widget game event on the display device when the determined stopping point in the primary gaming event is reached;
return to the primary gaming event after completion of the widget gaming event when the received outcome information for the widget game event includes a non-triggering outcome; and
initiate a group-play bonus event on the gaming apparatus after completion of the widget gaming event when the received outcome information for the widget game event includes a triggering outcome.

11. The gaming apparatus of claim 10, wherein the display device is a secondary display device separate from a primary display device used to display the base game on the gaming apparatus.

12. The gaming apparatus of claim 10, wherein the display device is a primary display device used to display the base game on the gaming apparatus.

13. The gaming apparatus of claim 10, wherein the widget gaming event is automatically initiated when the determined stopping point in the primary gaming event is reached.

14. The gaming apparatus of claim 10, wherein the processor is further configured to receive a player input during the widget gaming event, the received player input used to select one outcome among a plurality of possible outcomes included in the received outcome information for the widget game event, where initiation of the group-play bonus event or return to the primary gaming event is based on the selected outcome among the plurality of possible outcomes included in the received outcome information for the widget game event.

15. A method of facilitating a group-play bonus event on a gaming system including a plurality of gaming devices and a central processor, the method comprising:
receiving a wager at one of the gaming devices;
determining evaluations associated with the received wager;
storing the determined evaluations in an associated eligibility meter;
completing a first random draw using the central processor at a predefined time interval;
deducting an evaluation associated with each gaming device from the eligibility meter;
completing a second random draw using the central processor when a result of the first random draw satisfies a predefined condition;
generating a widget display on the gaming devices, wherein an outcome of the widget display is associated with a result of the second draw; and
initiating a group-play bonus event using the central processor when the result of the second random draw satisfies a trigger threshold.

16. The method of claim 15, wherein determining evaluations associated with the received wager includes:
determining an existing level of the associated eligibility meter;
adding a first number of evaluations corresponding to an amount of the wager when the determined level of the associated eligibility meter is below a predefined threshold; and
adding a second number of evaluations with associated multipliers corresponding to the amount of the wager when the determined level of the associated eligibility meter is above the predefined threshold.

17. The method of claim 16, further comprising determining a final payout for each gaming device based on the result of the group-play bonus event, where the final payout is multiplied by the multiplier associated with the deducted evaluations for each gaming device, respectively.

18. The method of claim 15, further comprising determining the trigger threshold for the second random draw, wherein the trigger threshold is determined based on a number of eligible gaming devices in the plurality of gaming devices.

19. The method of claim 15, further comprising selecting an initiating gaming device from the plurality of gaming devices, where the initiating gaming device is given an additional award modifier for use in the group-play bonus event.

20. The method of claim 15, wherein the outcome of the generated widget display for the initiating gaming device is different from the outcome of the generated widget displays from the remaining gaming devices.
